(19) United States
(12) Patent Application Publication
(10) Pub. No.: US 2026/0267695 A1
(43) Pub. Date: Sep. 10, 2026

(54) MEMORY ALLOCATING METHOD AND SYSTEM FOR NEURAL NETWORK OPERATORS, ELECTRONIC DEVICE, AND STORAGE MEDIUM

(71) Applicant: SHENZHEN CORERAIN TECHNOLOGIES CO., LTD., Shenzhen (CN)

(72) Inventors: Ming LI, Shenzhen (CN); Kuen Hung TSOI, Shenzhen (CN); Xinyu NIU, Shenzhen (CN)

(73) Assignee: SHENZHEN CORERAIN TECHNOLOGIES CO., LTD., Shenzhen (CN)

(21) Appl. No.: 19/556,592

(22) Filed: Mar. 4, 2026

(30) Foreign Application Priority Data
Mar. 5, 2025 (CN) 202510270803.7

(51) Int. Cl. G06F 9/50

(52) U.S. Cl. CPC G06F 9/5016; G06F 9/5038; G06F 9/5044

(57) ABSTRACT

A memory allocating method and system for neural network operators, an electronic device, and a storage medium is provided and includes: performing memory allocation for target operators successively in a first memory of a target chip based on a computing order according to a target occupied memory of the target operators; when a remaining storage space of the first memory satisfies a first preset condition, executing memory allocation for a current target operator to be allocated with memory in the first memory; and transmitting currently stored data of the first memory to a second memory of the target chip to continuously traverse the memory allocation of remaining target operators in the first memory in an idle state according to the computing order until memory allocation for all the target operators is completed.

### CROSS REFERENCE TO RELATED APPLICATION

This application claims priority to Chinese Patent Application No. 2025102708037 filed with the Chinese Patent Office on Mar. 5, 2025, the entire contents of each of which are incorporated herein by reference for all purposes.

### FIELD

The present disclosure relates to the technical field of deep learning, and particularly to a memory allocating method and system for neural network operators, an electronic device, and a storage medium.

### BACKGROUND

With the rapid development of deep learning technology, the scale and complexity of neural network models are constantly increasing, and the computing demands of the models are growing exponentially. To meet these demands, AI accelerators are widely applied to accelerating deep learning tasks.

However, with the expansion of model scale, large-grained operator operations (e.g., convolution, matrix multiplication, etc.) may consume more computing resources during the calculation process, and also increase the read and write demands for memory and on-chip cache. For most AI accelerators, computing resources, memory bandwidth and cache capacity are all valuable resources. To efficiently utilize these resources has become a key challenge for improving the model inference speed.

Currently, most AI accelerators adopt a hierarchical storage structure. This structure usually includes external storage (e.g., DRAM) and internal storage (e.g., SRAM or on-chip cache). The external storage has a large capacity but a low bandwidth, whereas the internal storage has a small capacity but a high bandwidth. Due to the limitation of internal storage space, the AI accelerators often need to split the operators into a plurality of small-grained operations to adapt to the internal storage space when executing large-grained operators.

How to split the operators based on the hierarchical storage structure is described in the prior art to ensure that the computing tasks can be executed efficiently in the limited internal storage space. However, the inventors of the present disclosure find that these operator splitting methods usually only focus on the splitting strategies of operators, while neglecting the optimization of memory allocation. The inventors of the present disclosure find that how to split the operators in combination with the optimized memory while the operators are split is not considered fully, which results in a low memory access efficiency, thereby affecting the model inference speed of the neural network.

### SUMMARY

The present disclosure provides a memory allocating method and system for neural network operators, an electronic device, and a storage medium, which aims to solve the problem that the model inference speed of the neural network is affected as the current operator splitting methods have a low memory access efficiency.

According to an aspect of the present disclosure, the present disclosure provides a memory allocating method for neural network operators, including: sorting network graph structures in a neural network model of a target chip based on a preset graph traversal algorithm to obtain a computing order of all target operators; determining a target occupied memory required by process data of the target operators; performing memory allocation for the target operators successively in a first memory of the target chip based on the computing order according to the target occupied memory of the target operators; in a case where a remaining storage space of the first memory satisfies a first preset condition, executing memory allocation for a current target operator to be allocated with memory in the first memory; and transmitting currently stored data of the first memory to a second memory of the target chip to continuously traverse the memory allocation of remaining target operators in the first memory in an idle state according to the computing order until memory allocation for all the target operators is completed.

According to some embodiments of the present disclosure, executing memory allocation for the current target operator to be allocated with memory in the first memory includes: splitting the current target operator to be allocated with memory into a plurality of target sub-operators based on a preset splitting mode; and executing memory allocation for the plurality of target sub-operators in the first memory based on a preset partition allocation mode.

According to some embodiments of the present disclosure, performing memory allocation for the target operators successively in a first memory of the target chip based on the computing order according to the target occupied memory of the target operators includes: when an operator adjacent to the current target operator to be allocated with memory is a non-reusable operator, reusing a memory starting address of the non-reusable operator as a starting address of the current target operator to be allocated with memory.

According to some embodiments of the present disclosure, the memory allocating method for neural network operators further includes: when the remaining storage space of the first memory satisfies a second preset condition, transmitting the currently stored data of the first memory to the second memory of the target chip to traverse memory allocation of the target operators in the first memory in the idle state until memory allocation of all the target operators is completed.

According to another aspect of the present disclosure, the present disclosure provides a memory allocating system for neural network operators, including an operator information processing unit and an operator memory allocating unit. The operator information processing unit is configured to sort network graph structures in a neural network model of a target chip based on a preset graph traversal algorithm to obtain a computing order of all target operators and determine a target occupied memory required by process data of the target operators. The operator memory allocating unit is configured to perform memory allocation for the target operators successively in a first memory of the target chip based on the computing order according to the target occupied memory of the target operators. The operator memory allocating unit is configured to, when a remaining storage space of the first memory satisfies a first preset condition, execute memory allocation for a current target operator to be allocated with memory in the first memory, and transmit currently stored data of the first memory to a second memory of the target chip to continuously traverse the memory allocation of a remaining target operators in the first memory in an idle state according to the computing order until memory allocation for all the target operators is completed.

According to some embodiments of the present disclosure, the operator memory allocating unit splits the current target operator to be allocated with memory into a plurality of target sub-operators based on a preset splitting mode. The operator memory allocating unit executes memory allocation for the plurality of target sub-operators in the first memory based on a preset partition allocation mode.

According to some embodiments of the present disclosure, when an operator adjacent to the current target operator to be allocated with memory is a non-reusable operator, the operator memory allocating unit reuses a memory starting address of the non-reusable operator as a starting address of the current target operator to be allocated with memory.

According to some embodiments of the present disclosure, when the remaining storage space of the first memory satisfies a second preset condition, the operator memory allocating unit transmits the currently stored data of the first memory to the second memory of the target chip to traverse memory allocation of the target operators in the first memory in the idle state until memory allocation of all the target operators is completed.

According to another aspect of the present disclosure, the present disclosure further provides an electronic device. The electronic device includes: one or more processors; and a storage device, configured to store one or more programs, where when the one or more programs are executed by the one or more processors, the one or more processors implement the memory allocating method for operators described above.

According to another aspect of the present disclosure, the present disclosure further provides a non-volatile computer-readable storage medium. The non-volatile computer-readable storage medium stores a computer program, where when executed by a processor, the computer program implements the memory allocating method for operators described above.

According to another aspect of the present disclosure, the present disclosure further provides a computer program product. The computer program product includes: a computer program stored in the computer-readable storage medium; and the computer program includes a program instruction, where when the program instruction is executed by a computer, the computer executes the memory allocating method for operators described above.

The present disclosure has the following beneficial effects:

According to the present disclosure, by sorting network graph structures in the neural network model of the target chip based on the preset graph traversal algorithm, the computing order of all target operators can be obtained, and memory allocation in the first memory can be achieved according to the target occupied memory and computing order required by the process data of the target operators. When the remaining storage space of the first memory satisfies the first preset condition, memory allocation can also be executed for the current target operator to be allocated with memory in the first memory. Then, currently stored data of the first memory is transmitted to the second memory of the target chip to continuously traverse the memory allocation of the remaining target operators in the first memory in the idle state according to the computing order until memory allocation for all target operators is completed.

According to the present disclosure, the target operators can be stored in the first memory based on the computing order of the target operators, and in combination with a memory optimized arrangement mode, the memory utilization ratio in the first memory can be improved. When the current target operator to be allocated with memory cannot be accommodated in the remaining storage space of the first memory, memory allocation can also be performed on the current target operator to be allocated with memory in the first memory, such that the number of data transfers to the second memory can be decreased. The present disclosure can achieve operator splitting and operator memory allocation in combination with optimized memory allocation, thereby improving the model inference speed of the neural network.

### BRIEF DESCRIPTION OF THE DRAWINGS

To illustrate the technical solutions in the embodiments of the present disclosure more clearly, the accompanying drawings required for describing the embodiments will be briefly introduced below. Apparently, the accompanying drawings in the following description are only some embodiments of the present disclosure, and those of ordinary skill in the art can obtain other accompanying drawings based on these drawings without exerting creative efforts.

FIG. 1 shows a process schematic diagram of a memory allocating method for operators in an embodiment of the present disclosure.

FIG. 2 shows a schematic structural diagram of an AI accelerator in an embodiment of the present disclosure.

FIG. 3 shows a schematic diagram of memory allocation for operators in an embodiment of the present disclosure.

FIG. 4 shows another schematic diagram of memory allocation for operators in an embodiment of the present disclosure.

FIG. 5 shows another process schematic diagram of a memory allocating method for operators in an embodiment of the present disclosure.

FIG. 6 shows another schematic diagram of memory allocation for operators in an embodiment of the present disclosure.

FIG. 7 shows another process schematic diagram of a memory allocating method for operators in an embodiment of the present disclosure.

FIG. 8 shows a schematic structural diagram of a memory system for operators in an embodiment of the present disclosure.

### DESCRIPTION OF REFERENCE NUMERALS

1, memory allocating system for operators; 10, operator information processing unit; 20, operator memory allocating unit.

### DETAILED DESCRIPTION OF EMBODIMENTS

The technical solutions of the present disclosure are clearly and completely described below in conjunction with the accompanying drawings in the embodiments of the present disclosure. Apparently, the described embodiments are only a part of the embodiments of the present disclosure, rather than all the embodiments. Based on the embodiments of the present disclosure, all other embodiments obtained by those skilled in the art without making creative efforts shall fall within the scope of the present disclosure.

The full English names and their Chinese definitions of the English abbreviations involved in the present invention are as follows:

AI accelerator: Artificial Intelligence Accelerator;

GPU: Graphics Processing Unit;

TPU: Tensor Processing Unit;

FPGA: Field-Programmable Gate Array;

DRAM: Dynamic Random Access Memory;

SRAM: Static Random Access Memory.

According to an aspect of the present disclosure, the present disclosure provides a memory allocating method for neural network operators.

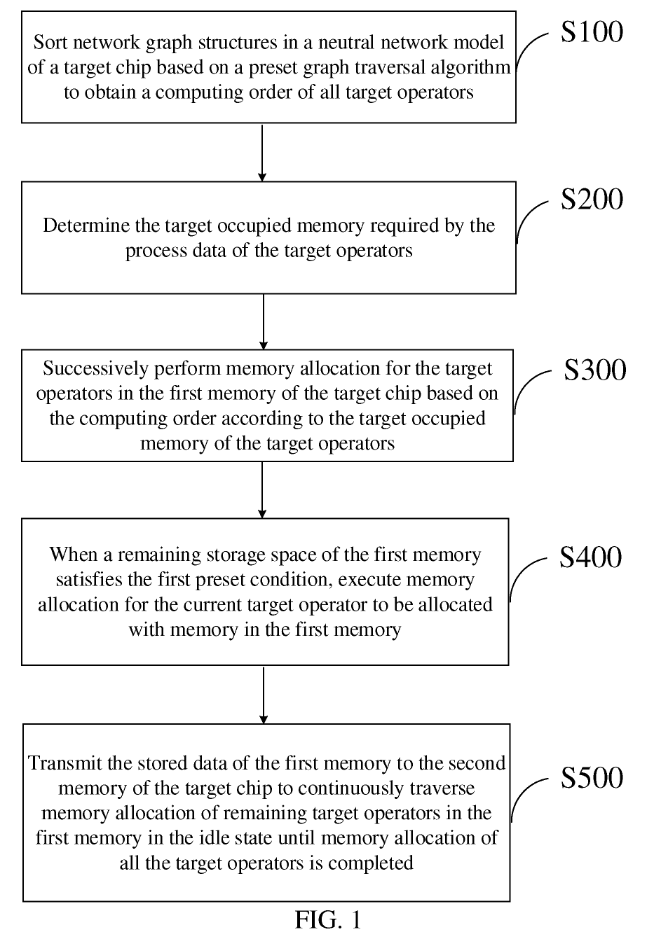

FIG. 1 shows a process schematic diagram of a memory allocating method for operators in an embodiment of the present disclosure. As shown in FIG. 1, the memory allocating method for operators includes steps S100-S500. Exemplarily, the memory allocating method for operators can be executed by a memory allocating system for operators with a computing capability.

According to an exemplary embodiment, in step S100, the memory allocating system for operators sorts network graph structures in a neural network model of a target chip based on a preset graph traversal algorithm to obtain a computing order of all target operators.

For example, the target chip can be a chip for which operator memory allocation is to be performed. As an embodiment, the target chip can be an AI accelerator (including, but not limited to, a GPU, a TPU, a FPGA, etc.).

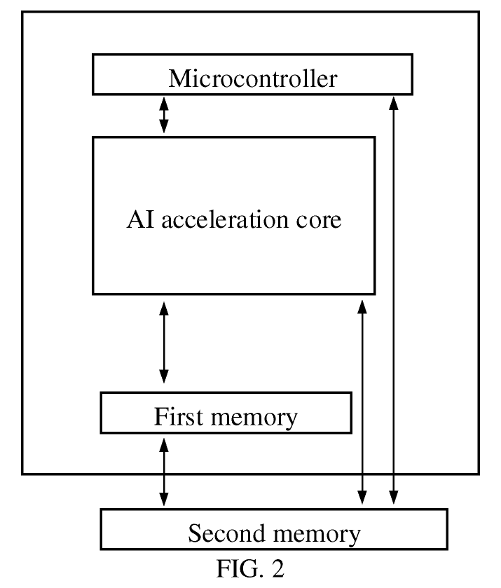

FIG. 2 shows a schematic structural diagram of the AI accelerator in an embodiment of the present disclosure.

As shown in FIG. 2, the AI accelerator can include a microcontroller, an AI accelerator core, a first memory, and a second memory.

The microcontroller is a control core of the AI accelerator, responsible for coordinating and managing work of all hardware modules; the AI accelerator core is a computing unit specially designed for AI tasks, configured to execute computationally intensive tasks such as deep learning, and machine learning; the first memory is on-chip storage of the AI accelerator, such as an SRAM; and the second memory is an external storage of the AI accelerator, such as a DRAM.

The network graph structures (or referred to as computational graphs) in the neural network model of the target chip are graphical representations for describing the computing process of the neural network model, including nodes and edges. The nodes represent computing operations in the neural network model, i.e., operators; and the edges represent flow directions of the operators between the nodes, i.e., describe the input and output relationship of computing operations.

According to the exemplary embodiment, the preset graph traversal algorithm can be a depth-first algorithm.

The memory allocating system for operators can sort the target operators (refer to operators to be computed in the network graph structures) in the network graph structures based on the depth-first algorithm to obtain the computing order of all target operators in the network graph structures. Arranged in this way, the memory allocating system for operators can execute memory allocation for all target operators based on the fixed computing order successively.

In step S200, the memory allocating system for operators determines the target occupied memory required by the process data of the target operators.

For example, the process data at least includes one of input data of the target operators, output data of the target operators, and parameter data of the target operators. Exemplarily, the process data includes, but is not limited to, data forms such as image data, text data, audio and video data or structured data.

The memory allocating system for operators calculates the size of the memory space required to be occupied by the input data, output data or parameter data of each of the target operators to obtain the target occupied memory corresponding to each of the target operators.

According to the exemplary embodiment, the target operators can include basic mathematical operation operators (i.e., numerical computation operator) and neural network layer operators. When the target operators are basic mathematical operation operators, the memory allocating system for operators only needs to compute one copy of the input data and output data thereof.

It can be understood herein that when the occupied memory of the basic mathematical operation operators is computed, it is only needed to consider the memory space occupied by the input data and output data of a single sample, i.e., the memory occupation of the single sample can represent a memory occupation mode of the whole operator. Arranged in this way, the present disclosure does not require repeated computation, such that the memory estimation process can be simplified.

In step S300, the memory allocating system for operators successively performs memory allocation for the target operators in the first memory of the target chip based on the computing order according to the target occupied memory of the target operators.

For example, the computing order of the target operators can be as follows: the first target operator, the second target operator, ...., the N^{th} target operator, where N is the total number of the target operators.

The memory allocating system for operators successively allocates corresponding memories for the first target operator, the second target operator, ...., the N^{th} target operator in the first memory in combination with corresponding target occupied memories.

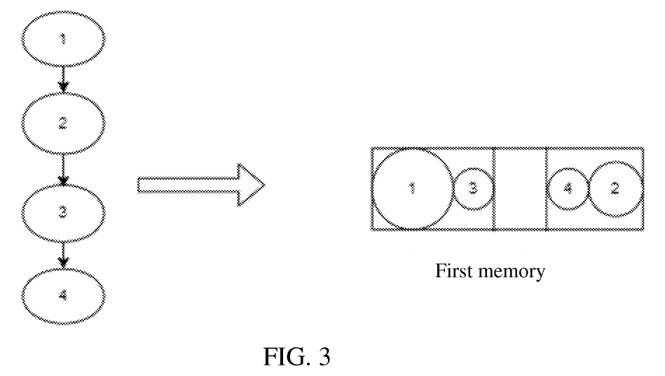

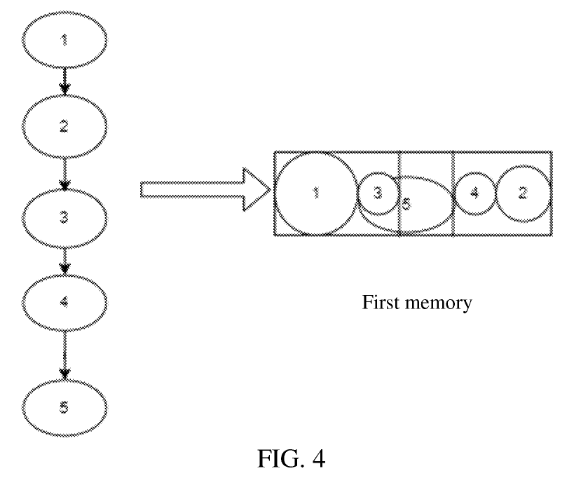

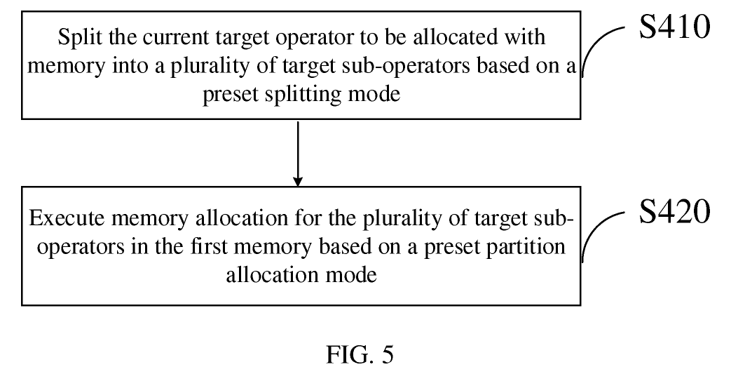

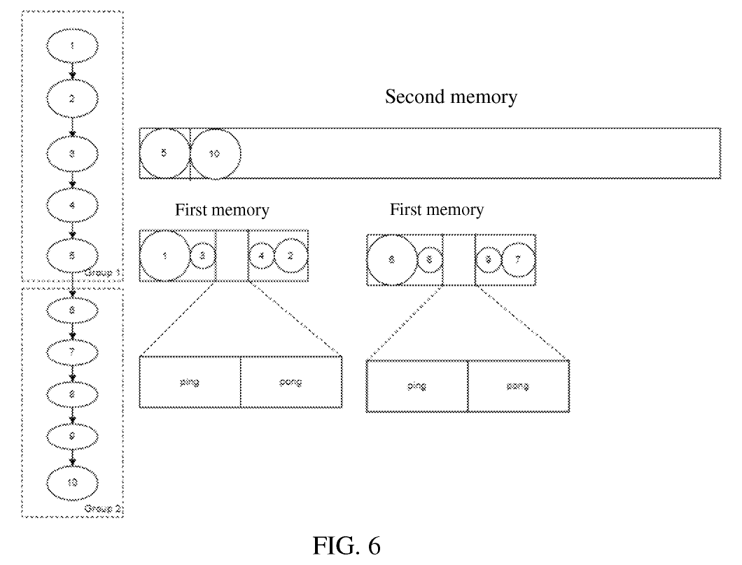

FIG. 3 shows a schematic diagram of memory allocation for operators in an embodiment of the present disclosure; FIG. 4 shows another schematic diagram of memory allocation for operators in an embodiment of the present disclosure; FIG. 5 shows another process schematic diagram of a memory allocating method for operators in an embodiment of the present disclosure; FIG. 6 shows another schematic diagram of memory allocation for operators in an embodiment of the present disclosure.

As an embodiment, as shown in FIG. 3, the memory allocating system for operators successively allocates corresponding memories for the first target operator 1, the second target operator 2, the third target operator 3 and the fourth target operator 4 in sequence in the first memory.

Optionally, in step S300, when an operator adjacent to the current target operator to be allocated with memory is a non-reusable operator, the memory allocating system for operators reuses a memory starting address of the non-reusable operator as a starting address of the current target operator to be allocated with memory.

For example, if the output data of a target operator is not reused, the memory allocating system for operators can mark the target operator as a non-reusable operator. In the memory allocation process of the target operator, when the operator adjacent to the current target operator to be allocated with memory (or approximately adjacent operator) is a non-reusable operator, the memory allocating system for operators can use the starting address of the non-reusable operator as the starting address of the current target operator to be allocated with memory to execute corresponding memory allocation.

As an embodiment, as shown in FIG. 4, when the third target operator 3 is the non-reusable operator, the fifth operator can reuse the starting address of the third target operator 3.

Through the above embodiments, to efficiently manage the memory allocation in the first memory, by employing an optimized memory allocation strategy, the memory occupied by an obsolete operator is marked as an obsolete memory in combination with a memory reuse and invalid memory recovery mechanism for subsequent use. Arranged in this way, the present disclosure can reduce memory fragmentation and improve the memory utilization ratio of on-chip storage resources.

In step S400, when the remaining storage space of the first memory satisfies the first preset condition, the memory allocating system for operators executes memory allocation for the current target operator to be allocated with memory in the first memory.

For example, the first preset condition can be as follows: the remaining storage space of the first memory is smaller than the target occupied space of the current target operator to be allocated with memory, and the remaining storage space of the first memory is greater than or equal to a preset threshold. The minimum computation load required to compute the current target operator to be allocated with memory in the AI accelerator core is marked as M, and the preset threshold is 2M.

Optionally, as shown in FIG. 5, step S400 can further include steps S410-S420.

In step S410, the memory allocating system for operators splits the current target operator to be allocated with memory into a plurality of target sub-operators based on a preset splitting mode.

For example, the preset splitting mode can split the target occupied memory of the current target operator to be allocated with memory, with the minimum computation load M as a splitting unit.

Exemplarily, when the remaining storage space of the first memory is smaller than the target occupied space of the current target operator to be allocated with memory and greater than or equal to 2M, the memory allocating system for operators splits the current target operator to be allocated with memory , with M as the splitting unit, to obtain N target sub-operators S1 (i.e., the size of the occupied memory required by each of the target operators S1 is M).

In step S420, the memory allocating system for operators executes memory allocation for the plurality of target sub-operators in the first memory based on a preset partition allocation mode.

Optionally, the preset partition allocation mode is a Ping-Pong memory allocation mode.

The Ping-Pong memory allocation mode (Ping-Pong Mode) can perform data movement and task computation via a partition mechanism (double buffer, including a Ping region and a Pong region). The data movement and task computation can be performed alternately in the Ping region and the Pong region.

For example, an operator memory allocating system allocates, in a first memory, a 2M memory space to N target sub-operators S1 (that is, each of a Ping region and a Pong region has a size of 1M in the present disclosure), and, based on a Ping-Pong memory allocation scheme, configures starting addresses of memory to be occupied by the N target sub-operators S1 within the allocated 2M memory space, thereby performing corresponding memory allocation.

Through the above embodiments, memory allocation can be performed on the plurality of target sub-operators in the memory space of the first memory in the Ping-Pong mode, such that the plurality of target sub-operators can be moved while computed. Arranged in this way, the present disclosure can decrease the number of data transfers to the second memory and improve the memory utilization ratio of the AI accelerator.

In step S500, the memory allocating system for operators transmits the stored data of the first memory to the second memory of the target chip to continuously traverse memory allocation of the remaining target operators in the first memory in the idle state until memory allocation of all the target operators is completed.

For example, after memory allocation on the plurality of target sub-operators is performed based on the Ping-Pong memory allocation mode, the AI accelerator core outputs the memory allocation result to the second memory and transfers the currently stored data of the first memory to the second memory.

Exemplarily, the currently stored data of the first memory is stored data that has not been reclaimed. In the subsequent operator computation process, if this data is still need to be used, the memory allocating system for operators can also transfer the stored data back to the previous storage location of the first memory, facilitating subsequent operator computation.

After the memory allocating system for operators transfers the stored data of the first memory to the second memory, the first memory is in the idle state again. Based on the above memory allocating method for operators, the memory allocating system for operators continuously traverses the remaining operators based on the computing order of the target operators until the remaining storage space of the first memory satisfies the first preset condition again. The memory allocating system for operators splits the target operators again and executes memory allocation for the plurality of target sub-operators again in the first memory in the preset partition allocation mode. This cycle is executed until the memory allocation for all target operators is completed.

According to the exemplary embodiment, the memory allocating system for operators can mark the target operators allocated with memory in the same batch in the first memory as one group.

Exemplarily, as shown in FIG. 6, the target operators 1-5 allocated with memory in the first memory in the first batch are Group 1; the target operators 6-10 allocated with memory in the first memory in the second batch is Group 2, and so on.

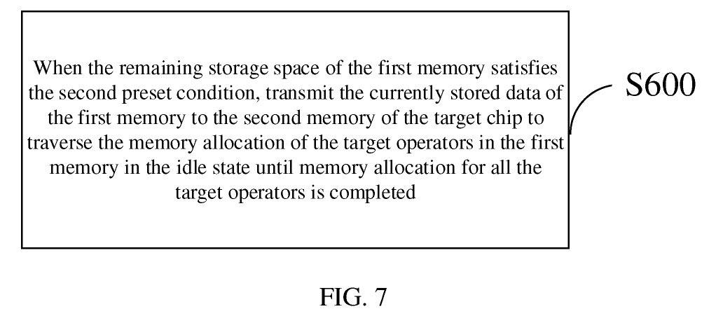

FIG. 7 shows another process schematic diagram of a memory allocating method for operators in an embodiment of the present disclosure. As shown in FIG. 7, the memory allocating method for operators can further include step S600.

Optionally, in step S600, when the remaining storage space of the first memory satisfies the second preset condition, the memory allocating system for operators transmits the currently stored data of the first memory to the second memory of the target chip to traverse the memory allocation of the target operators in the first memory in the idle state until memory allocation for all target operators is completed.

For example, the second preset condition can be as follows: the remaining storage space of the first memory is smaller than the target occupied space of the current target operator to be allocated with memory, and the remaining storage space of the first memory is less than a preset threshold. The minimum computation load required to compute the current target operator to be allocated with memory in the AI accelerator core is marked as M, and the preset threshold is 2M.

Exemplarily, when the remaining storage space of the first memory is smaller than the target occupied space of the current target operator to be allocated with memory and is less than 2M, the memory allocating system for operators transfers the currently stored data of the first memory to the second memory, such that the first memory is in the idle state again. The memory allocating system for operators continuously executes operator memory allocation in the next batch (i.e., the target operators that satisfy the second preset condition enter memory allocation computation of the next Group) at this time. This cycle is executed until the memory allocation for all target operators is completed.

Through the above embodiment, by sorting network graph structures in the neural network model of the target chip based on a preset graph traversal algorithm, the computing order of all target operators can be obtained. Memory allocation in the first memory can be achieved according to the target occupied memory and computing order required by the process data of the target operators. When the remaining storage space of the first memory satisfies the first preset condition, the current target operator to be allocated with memory is split into a plurality of target sub-operators based on a preset splitting mode, and memory allocation can also be executed for the current target operator to be allocated with memory in the first memory. Then, currently stored data of the first memory is transmitted to the second memory of the target chip to continuously traverse the memory allocation of the remaining target operators in the first memory in the idle state according to the computing order until memory allocation for all target operators is completed.

According to the present disclosure, the target operators can be stored in the first memory based on the computing order of the target operators, and in combination with a memory optimized arrangement mode, the memory utilization ratio in the first memory can be improved. When the current target operator to be allocated with memory cannot be accommodated in the remaining storage space of the first memory, the current target operator to be allocated with memory is split into a plurality of target sub-operators based on the minimum computational load required in computation of the AI accelerator core, and memory allocation can also be performed on the current target operator to be allocated with memory in the first memory, such that the number of data transfers to the second memory can be decreased. The present disclosure can achieve operator splitting and operator memory allocation in combination with optimized memory allocation, thereby improving the model inference speed of the neural network.

According to another aspect of the present disclosure, the present disclosure further provides a memory allocating system for neural network operators.

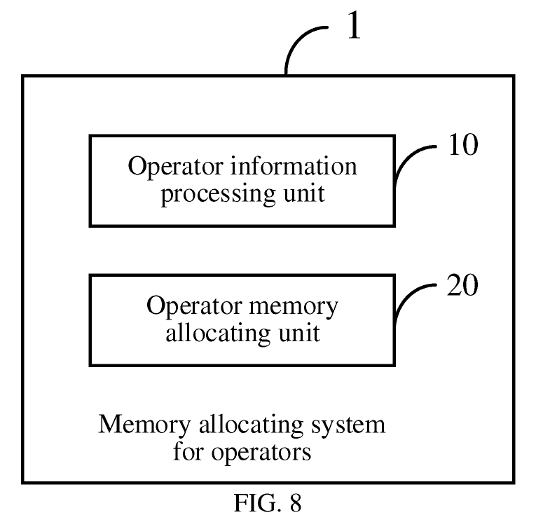

FIG. 8 shows a schematic structural diagram of a memory system for operators in an embodiment of the present disclosure. As shown in FIG. 8, the memory allocating system 1 for operators can include an operator information processing unit 10 and an operator memory allocating unit 20.

According to the exemplary embodiment, the operator information processing unit 10 sorts network graph structures in the neural network model of the target chip based on a preset graph traversal algorithm, to obtain the computing order of all target operators.

For example, the target chip can be a chip for performing memory allocation for operators. As an embodiment, the target chip can be an AI accelerator (including, but not limited to, a GPU, a TPU, a FPGA, etc.).

As shown in FIG. 2, the AI accelerator can include a microcontroller, an AI accelerator core, a first memory, and a second memory.

The microcontroller is a control core of the AI accelerator, responsible for coordinating and managing work of all hardware modules; the AI accelerator core is a computing unit specially designed for AI tasks, configured to execute computationally intensive tasks such as deep learning, and machine learning; the first memory is on-chip storage of the AI accelerator, such as an SRAM; and the second memory is an external storage of the AI accelerator, such as a DRAM.

The network graph structures (or referred to as computational graphs) in the neural network model of the target chip are graphical representations for describing the computing process of the neural network model, including nodes and edges. The nodes represent computing operations in the neural network model, i.e., operators; and the edges represent flow directions of the operators between the nodes, i.e., describe the input and output relationship of computing operations.

According to the exemplary embodiment, the preset graph traversal algorithm can be a depth-first algorithm.

The operator information processing unit 10 can sort the target operators (the operators to be computed in the network graph structures) based on a depth first algorithm, to obtain the computing order of all target operators in the network graph structures. Arranged in this way, the memory allocating system for operators can execute memory allocation for all target operators based on the fixed computing order successively.

The operator information processing unit 10 determines the target occupied memory required by process data of the target operators.

For example, the process data at least includes one of input data of the target operators, output data of the target operators, and parameter data of the target operators. Exemplarily, the process data includes, but is not limited to, data forms such as image data, text data, audio and video data or structured data.

The operator information processing unit 10 calculates size of the memory space occupied by the input data, output data or parameter data of each of the target operators to obtain the target occupied memory corresponding to each of the target operators.

According to the exemplary embodiment, the target operators can include basic mathematical operation operators (i.e., numerical computation operator) and neural network layer operators. When the target operators are the basic mathematical operation operators, the operator information processing unit 10 only needs to compute one copy of the input data and output data thereof.

It can be understood herein that when the occupied memory of the basic mathematical operation operators is computed, it is only needed to consider the memory space occupied by the input data and output data of a single sample, i.e., the memory occupation of the single sample can represent a memory occupation mode of the whole operator. Arranged in this way, the present disclosure does not require repeated computation, such that the memory estimation process can be simplified.

The operator memory allocating unit 20 performs memory allocation for the target operators successively in the first memory of the target chip based on the computing order according to the target occupied memory of the target operators.

For example, the computing order of the target operators can be as follows: the first target operator, the second target operator...., and the N^{th} target operator, where N is the total number of the target operators.

The memory allocating system for operators successively allocates corresponding memories for the first target operator, the second target operator...., and the N^{th} target operator in the first memory in combination with corresponding target occupied memories.

As an embodiment, as shown in FIG. 3, the memory allocating system for operators successively allocates corresponding memories for the first target operator 1, the second target operator 2, the third target operator 3 and the fourth target operator 4 in sequence in the first memory.

Optionally, when an operator adjacent to the current target operator to be allocated with memory is a non-reusable operator, the operator memory allocating unit 20 reuses a memory starting address of the non-reusable operator as a starting address of the current target operator to be allocated with memory.

For example, if the output data of a target operator is not reused, the operator memory allocating unit 20 can mark the target operator as a non-reusable operator. In the memory allocation process of the target operator, when the operator adjacent to the current target operator to be allocated with memory (or approximately adjacent operator) is a non-reusable operator (or also known as an obsolete operator), the operator memory allocating unit 20 can use the starting address of the non-reusable operator as the starting address of the current target operator to be allocated with memory to execute corresponding memory allocation.

As an embodiment, as shown in FIG. 4, when the third target operator 3 is the non-reusable operator, the fifth operator can reuse the starting address of the third target operator 3.

Through the above embodiments, to efficiently manage the memory allocation in the first memory, by employing an optimized memory allocation strategy, the memory occupied by an obsolete operator is marked as an obsolete memory in combination with a memory reuse and invalid memory recovery mechanism for subsequent use. Arranged in this way, the present disclosure can reduce memory fragmentation and improve the memory utilization ratio of on-chip storage resources.

According to the exemplary embodiment, when the remaining storage space of the first memory satisfies the first preset condition, the operator memory allocating unit 20 executes memory allocation for the current target operator to be allocated with memory in the first memory.

For example, the first preset condition can be as follows: the remaining storage space of the first memory is smaller than the target occupied space of the current target operator to be allocated with memory, and the remaining storage space of the first memory is greater than or equal to a preset threshold. The minimum computation load required to compute the current target operator to be allocated with memory in the AI accelerator core is marked as M, and the preset threshold is 2M.

Optionally, the operator memory allocating unit 20 splits the current target operator to be allocated with memory into a plurality of target sub-operators based on a preset splitting mode.

For example, the preset splitting mode can split the target occupied memory of the current target operator to be allocated with memory, with the minimum computation load M as a splitting unit.

Exemplarily, when the remaining storage space of the first memory is smaller than the target occupied space of the current target operator to be allocated with memory and greater than or equal to 2M, the operator memory allocating unit 20 splits the current target operator to be allocated with memory, with M as the splitting unit, to obtain N target sub-operators S1 (i.e., the size of the occupied memory required by each of the target operators S1 is M).

The operator memory allocating unit 20 executes memory allocation for the current target operator to be allocated with memory in the first memory.

Optionally, the preset partition allocation mode is a Ping-Pong memory allocation mode.

The Ping-Pong memory allocation mode (Ping-Pong Mode) can perform data movement and task computation via a partition mechanism (double buffer, including a Ping region and a Pong region). The data movement and task computation can be performed alternately in the Ping region and the Pong region.

For example, the operator memory allocating unit 20 allocates, in a first memory, a 2M memory space for N target sub-operators S1 (that is, in the present disclosure, each of a Ping region and a Pong region has a size of 1M), and, based on a Ping-Pong memory allocation mode, configures, within the allocated 2M memory space, a starting address of memory to be occupied by the N target sub-operators S1, so as to perform corresponding memory allocation.

Through the above embodiments, memory allocation can be performed on the plurality of target sub-operators in the memory space of the first memory in the Ping-Pong mode, such that the plurality of target sub-operators can be moved while computed. Arranged in this way, the present disclosure can decrease the number of data transfers to the second memory and improve the memory utilization ratio of the AI accelerator.

The operator memory allocating unit 20 transmits the stored data of the first memory to the second memory of the target chip to continuously traverse memory allocation of the remaining target operators in the first memory in the idle state until memory allocation of all the target operators is completed.

For example, after memory allocation on the plurality of target sub-operators is performed based on the Ping-Pong memory allocation mode, the AI accelerator core outputs the memory allocation result to the second memory and transfers the currently stored data of the first memory to the second memory.

Exemplarily, the currently stored data of the first memory is stored data that has not been reclaimed. In the subsequent operator computation process, if this data is still need to be used, the operator memory allocating unit 20 can also transfer the stored data back to the previous storage location of the first memory, facilitating subsequent operator computation.

After the operator memory allocating unit 20 transfers the stored data of the first memory to the second memory, the first memory is in the idle state again. Based on the above memory allocating method for operators, the operator memory allocating unit 20 continuously traverses the remaining operators based on the computing order of the target operators until the remaining storage space of the first memory satisfies the first preset condition again. The operator memory allocating unit 20 splits the target operators again and executes memory allocation for the plurality of target sub-operators again in the first memory in the preset partition allocation mode. This cycle is executed until the memory allocation for all target operators is completed.

According to the exemplary embodiment, the operator memory allocating unit 20 can mark the target operators allocated with memory in the same batch in the first memory as one group.

Exemplarily, as shown in FIG. 6, the target operators 1-5 allocated with memory in the first memory in the first batch are Group 1; the target operators 6-10 allocated with memory in the first memory in the second batch is Group 2, and so on.

Optionally, when the remaining storage space of the first memory satisfies a second preset condition, the operator memory allocating unit 20 transmits the currently stored data of the first memory to the second memory of the target chip to traverse memory allocation of the target operators in the first memory in the idle state until memory allocation of all the target operators is completed.

For example, the second preset condition can be as follows: the remaining storage space of the first memory is smaller than the target occupied space of the current target operator to be allocated with memory, and the remaining storage space of the first memory is less than a preset threshold. The minimum computation load required to compute the current target operator to be allocated with memory in the AI accelerator core is marked as M, and the preset threshold is 2M.

Exemplarily, when the remaining storage space of the first memory is smaller than the target occupied space of the current target operator to be allocated with memory and is less than 2M, the operator memory allocating unit 20 transfers the currently stored data of the first memory to the second memory, such that the first memory is in the idle state again. The operator memory allocating unit 20 continuously executes operator memory allocation in the next batch (i.e., the target operators that satisfy the second preset condition enter the memory allocation computation of the next Group) at this time. This cycle is executed until the memory allocation for all target operators is completed.

Through the above embodiment, by sorting network graph structures in the neural network model of the target chip based on a preset graph traversal algorithm, the computing order of all target operators can be obtained. Memory allocation in the first memory can be achieved according to the target occupied memory and computing order required by the process data of the target operators. When the remaining storage space of the first memory satisfies the first preset condition, the current target operator to be allocated with memory is split into a plurality of target sub-operators based on a preset splitting mode, and memory allocation can also be executed for the current target operator to be allocated with memory in the first memory. Then, currently stored data of the first memory is transmitted to the second memory of the target chip to continuously traverse the memory allocation of the remaining target operators in the first memory in the idle state according to the computing order until memory allocation for all target operators is completed.

According to the present disclosure, the target operators can be stored in the first memory based on the computing order of the target operators, and in combination with a memory optimized arrangement mode, the memory utilization ratio in the first memory can be improved. When the current target operator to be allocated with memory cannot be accommodated in the remaining storage space of the first memory, the current target operator to be allocated with memory is split into a plurality of target sub-operators based on the minimum computational load required in computation of the AI accelerator core, and memory allocation can also be performed on the current target operator to be allocated with memory in the first memory, such that the number of data transfers to the second memory can be decreased. The present disclosure can achieve operator splitting and operator memory allocation in combination with optimized memory allocation, thereby improving the model inference speed of the neural network.

According to another aspect of the present disclosure, the present disclosure further provides an electronic device. The electronic device includes one or more processors; and a storage device, configured to store one or more programs, where when the one or more programs are executed by the one or more processors, the one or more processors implement the memory allocating method for operators described above.

According to another aspect of the present disclosure, the present disclosure further provides a non-volatile computer-readable storage medium. The non-volatile computer-readable storage medium stores a computer program, where when executed by a processor, the computer program implements the memory allocating method for operators described above.

According to another aspect of the present disclosure, the present disclosure further provides a computer program product. The computer program product includes: a computer program stored in the computer-readable storage medium; and the computer program includes a program instruction, where when the program instruction is executed by a computer, the computer executes the memory allocating method for operators described above.

Finally, it should be noted that the above description is merely a preferred embodiment of the present disclosure and is not intended to limit the present disclosure. Although the present disclosure has been described in detail with reference to the above embodiments, those skilled in the art can still modify the technical solutions of the above embodiments or make equivalent substitutions for some of their technical features. Any modification, equivalent replacement, improvement or the like made within the spirit and principle of the present disclosure shall fall within the protection scope of the present disclosure.

What is claimed is:

1. A memory allocating method for neural network operators, comprising:
sorting network graph structures in a neural network model of a target chip based on a preset graph traversal algorithm to obtain a computing order of all target operators;
determining a target occupied memory required by process data of the target operators;
performing memory allocation for the target operators successively in a first memory of the target chip based on the computing order according to the target occupied memory of the target operators;
in a case where a remaining storage space of the first memory satisfies a first preset condition, executing memory allocation for a current target operator to be allocated with memory in the first memory; and
transmitting currently stored data of the first memory to a second memory of the target chip to continuously traverse the memory allocation of remaining target operators in the first memory in an idle state according to the computing order until memory allocation for all the target operators is completed.

2. The memory allocating method for neural network operators according to claim 1, wherein the executing memory allocation for a current target operator to be allocated with memory in the first memory comprises:
splitting the current target operator to be allocated with memory into a plurality of target sub-operators based on a preset splitting mode; and
executing memory allocation for the plurality of target sub-operators in the first memory based on a preset partition allocation mode.

3. The memory allocating method for neural network operators according to claim 1, wherein the performing memory allocation for the target operators successively in a first memory of the target chip based on the computing order according to the target occupied memory of the target operators comprises:
in a case where an operator adjacent to the current target operator to be allocated with memory is a non-reusable operator, reusing a memory starting address of the non-reusable operator as a starting address of the current target operator to be allocated with memory.

4. The memory allocating method for neural network operators according to claim 1, further comprising:
in a case where the remaining storage space of the first memory satisfies a second preset condition, transmitting the currently stored data of the first memory to the second memory of the target chip to traverse memory allocation of the target operators in the first memory in the idle state until memory allocation of all the target operators is completed.

5. A memory allocating system for neural network operators, comprising:
an operator information processing unit, configured to sort network graph structures in a neural network model of a target chip based on a preset graph traversal algorithm to obtain a computing order of all target operators and determine a target occupied memory required by process data of the target operators; and
an operator memory allocating unit, configured to perform memory allocation for the target operators successively in a first memory of the target chip based on the computing order according to the target occupied memory of the target operators; in a case where a remaining storage space of the first memory satisfies a first preset condition, execute memory allocation for the current target operator to be allocated with memory in the first memory; and transmit currently stored data of the first memory to a second memory of the target chip to continuously traverse the memory allocation of remaining target operators in the first memory in an idle state according to the computing order until memory allocation for all the target operators is completed.

6. The memory allocating system for neural network operators according to claim 5, wherein the operator memory allocating unit is further configured to:
split the current target operator to be allocated with memory into a plurality of target sub-operators based on a preset splitting mode; and
execute memory allocation for the plurality of target sub-operators in the first memory based on a preset partition allocation mode.

7. The memory allocating system for neural network operators according to claim 5, wherein in a case where an operator adjacent to the current target operator to be allocated with memory is a non-reusable operator, the operator memory allocating unit is further configured to reuse a memory starting address of the non-reusable operator as a starting address of the current target operator to be allocated with memory.

8. The memory allocating system for neural network operators according to claim 5, wherein in a case where the remaining storage space of the first memory satisfies a second preset condition, the operator memory allocating unit is further configured to transmit the currently stored data of the first memory to the second memory of the target chip to traverse memory allocation of the target operators in the first memory in the idle state until memory allocation of all the target operators is completed.

9. An electronic device, comprising:
one or more processors; and
a storage device, configured to store one or more programs, wherein
when the one or more programs are executed by the one or more processors, the one or more processors implement the memory allocating method for neural network operators, wherein the method comprises:
sorting network graph structures in a neural network model of a target chip based on a preset graph traversal algorithm to obtain a computing order of all target operators;
determining a target occupied memory required by process data of the target operators;
performing memory allocation for the target operators successively in a first memory of the target chip based on the computing order according to the target occupied memory of the target operators;
in a case where a remaining storage space of the first memory satisfies a first preset condition, executing memory allocation for a current target operator to be allocated with memory in the first memory; and
transmitting currently stored data of the first memory to a second memory of the target chip to continuously traverse the memory allocation of remaining target operators in the first memory in an idle state according to the computing order until memory allocation for all the target operators is completed.

10. The electronic device according to claim 9, wherein the executing memory allocation for a current target operator to be allocated with memory in the first memory comprises:
splitting the current target operator to be allocated with memory into a plurality of target sub-operators based on a preset splitting mode; and
executing memory allocation for the plurality of target sub-operators in the first memory based on a preset partition allocation mode.

11. The electronic device according to claim 9, wherein the performing memory allocation for the target operators successively in a first memory of the target chip based on the computing order according to the target occupied memory of the target operators comprises:
in a case where an operator adjacent to the current target operator to be allocated with memory is a non-reusable operator, reusing a memory starting address of the non-reusable operator as a starting address of the current target operator to be allocated with memory.

12. The electronic device according to claim 9, further comprising:
in a case where the remaining storage space of the first memory satisfies a second preset condition, transmitting the currently stored data of the first memory to the second memory of the target chip to traverse memory allocation of the target operators in the first memory in the idle state until memory allocation of all the target operators is completed.
